(19) United States
(12) Patent Application Publication
(10) Pub. No.: US 2016/0097020 A1
(43) Pub. Date: Apr. 7, 2016

(54) AQUEOUS SOLUTIONS CONTAINING A COMPLEXING AGENT IN HIGH CONCENTRATION

(71) Applicant: BASF SE, Ludwigshafen (DE)

(72) Inventors: Markus Christian BIEL, Mannheim (DE); Thomas GREINDL, Maxdorf (DE); Markus HARTMANN, Neustadt (DE); Wolfgang STAFFEL, Otterstadt (DE); Marta REINOSO GARCIA, Dossenheim (DE)

(73) Assignee: BASF SE, Ludwigshafen (DE)

(21) Appl. No.: 14/892,820

(22) PCT Filed: May 13, 2014
(86) PCT No.: PCT/EP2014/059720

§ 371 Date: Nov. 20, 2015

(30) Foreign Application Priority Data
May 27, 2013 (EP) 13169339.2

(51) Int. Cl. C11D 3/37; F17D 1/08; C11D 3/33

(52) U.S. Cl. CPC C11D 3/3723; C11D 3/33; F17D 1/08

(57) ABSTRACT

Aqueous solution comprising (A) in the range of from 30 to 60% by weight of a complexing agent, selected from the alkali metal salts of methylglycine diacetic acid and the alkali metal salts of glutamic acid diacetic acid, (B) in the range of from 700 ppm to 7% by weight of a polymer being selected from polyamines, the N atoms being partially or fully substituted with CH₂COOH groups, partially or fully neutralized with alkali metal cations, ppm and percentages referring to the total respective aqueous solution

The present invention is directed towards an aqueous solution comprising
(A) in the range of from 30 to 60% by weight of a complexing agent, selected from the alkali metal salts of methylglycine diacetic acid and the alkali metal salts of glutamic acid diacetic acid, preferably at least 35% by weight,
(B) in the range of from 700 ppm to 7% by weight of a polymer being selected from polyamines, the N atoms being partially or fully substituted with CH₂COOH groups, partially or fully neutralized with alkali metal cations,

ppm and percentages referring to the total respective aqueous solution.

Complexing agents such as methyl glycine diacetic acid (MGDA) and glutamic acid diacetic acid (GLDA) and their respective alkali metal salts are useful sequestrants for alkaline earth metal ions such as Ca²+and Mg²+. For that reason, they are recommended and used for various purposes such as laundry detergents and for automatic dishwashing (ADW) formulations, in particular for so-called phosphate-free laundry detergents and phosphate-free ADW formulations. For shipping such complexing agents, in most cases either solids such as granules are being applied or aqueous solutions.

Many industrial users wish to obtain complexing agents in aqueous solutions that are as highly concentrated as possible. The lower the concentration of the requested complexing agent the more water is being shipped. Said water adds to the costs of transportation, and it has to be removed later. Although about 40% by weight solutions of MGDA and even 45% by weight solutions of GLDA can be made and stored at room temperature, local or temporarily colder solutions may lead to precipitation of the respective complexing agent, as well as nucleating by impurities. Said precipitations may lead to incrustations in pipes and containers, and/or to impurities or inhomogeneity during formulation.

Granules and powders are useful because the amount of water shipped can be neglected but for most mixing and formulation processes an extra dissolution step is required.

Additives that may enhance the solubility of the respective complexing agents may be considered but such additives should not negatively affect the properties of the respective complexing agent.

It was therefore the objective of the present invention to provide highly concentrated aqueous solutions of complexing agents such as MGDA or GLDA that are stable at temperatures in the range from zero to 50° C. It was further an objective of the present invention to provide a method for manufacture of highly concentrated aqueous solutions of complexing agents such as MGDA or GLDA that are stable at temperatures in the range from zero to 50° C. Neither such method nor such aqueous solution should require the use of additives that negatively affect the properties of the respective complexing agent.

Accordingly, the aqueous solutions defined at the outset have been found, hereinafter also being referred to as aqueous solutions according to the invention.

Aqueous solutions according to the invention contain
(A) in the range of from 30 to 60% by weight of a complexing agent, hereinafter also being referred as “complexing agent (A)”, selected from the alkali metal salts of methylglycine diacetic acid and the alkali metal salts of glutamic acid diacetic acid, preferably at least 35% by weight,
(B) in the range of from 700 ppm to 7% by weight, preferably 5,000 ppm to 5% by weight, even more preferably up to 2.5% by weight of a polymer, being selected from polyamines, the N atoms being partially or fully substituted with CH₂COOH groups, partially or fully neutralized with alkali metal cations, said polymer hereinafter also being referred to as “polymer (B)”,

ppm and percentages referring to the total respective aqueous solution according to the invention. In the context of the present invention, quantities in ppm always refer to ppm by weight unless expressly noted otherwise.

Complexing agent (A) is selected from alkali metal salts of methylglycine diacetic acid and the alkali metal salts of glutamic acid diacetic acid.

In the context of the present invention, alkali metal salts of methylglycine diacetic acid are selected from lithium salts, potassium salts and preferably sodium salts of methylglycine diacetic acid. Methylglycine diacetic acid can be partially or preferably fully neutralized with the respective alkali. In a preferred embodiment, an average of from 2.7 to 3 COOH groups of MGDA is neutralized with alkali metal, preferably with sodium. In a particularly preferred embodiment, complexing agent (A) is the trisodium salt of MGDA.

Likewise, alkali metal salts of glutamic acid diacetic acid are selected from lithium salts, potassium salts and preferably sodium salts of glutamic acid diacetic acid. Glutamic acid diacetic acid can be partially or preferably fully neutralized with the respective alkali. In a preferred embodiment, an average of from 3.5 to 4 COOH groups of MGDA is neutralized with alkali metal, preferably with sodium. In a particularly preferred embodiment, complexing agent (A) is the tetrasodium salt of GLDA.

In one embodiment of the present invention, aqueous solutions according to the invention contain in the range of from 30 to 60% by weight alkali metal salt of MGDA as complexing agent (A), preferably 35 to 50% by weight and even more preferably 40 to 45% by weight. In another very preferred embodiment, aqueous solutions according to the invention contain in the range of from 42 to 48% by weight alkali metal salt of MGDA as complexing agent (A).

In one embodiment of the present invention, aqueous solutions according to the invention contain in the range of from 30 to 60% by weight alkali metal salt of GLDA as complexing agent (A), preferably 40 to 58% by weight and even more preferably 44 to 50 by weight. Complexing agent (A) can be selected from racemic mixtures of alkali metal salts of MGDA or GLDA, and of the pure enantiomers such as alkali metal salts of L-MGDA, alkali metal salts of

L-GLDA, alkali metal salts of D-MGDA and alkali metal salts of D-GLDA, and of mixtures of enantiomerically enriched isomers.

In any way, minor amounts of complexing agent (A) may bear a cation other than alkali metal. It is thus possible that minor amounts, such as 0.01 to 5 mol-% of total complexing agent (A) bear alkali earth metal cations such as Mg²+ or Ca²+, or an Fe²+ or Fe³+ cation.

Aqueous solutions according to the invention further contain a polymer, hereinafter also being referred to as polymer (B), the amount being in the range of from 700 ppm to 7% by weight, preferably 1,000 ppm to 5% by weight, even more preferably up to 2.5% by weight. Polymer (B) is selected from polyamines, the N atoms being partially or fully substituted with CH₂COOH groups, partially or fully neutralized with alkali metal cations.

The term “polyamine” in the context with polymer (B) refers to polymers and copolymers that contain at least one amino group per repeating unit. Said amino group may be selected from NH₂ groups, NH groups and preferably tertiary amino groups. In polymer (B), tertiary amino groups are preferred since the basic polyamine has been converted to carboxymethyl derivatives, and the N atoms are fully substituted or preferably partially, for example 50 to 95 mol-%, preferably 70 to 90 mol-%, substituted with CH₂COOH groups, partially or fully neutralized with alkali metal cations. In the context of the present invention, such polymers (B) in which more than 95 mol-% to 100 mol-% of the N atoms are substituted with CH₂COOH groups will be considered to be fully substituted with CH₂COOH groups. NH₂ groups from, e.g., polyvinylamines or polyalkylenimines can be substituted with one or two CH₂COOH group(s) per N atom, preferably with two CH₂COOH groups per N atom.

The numbers of CH₂COOH groups in polymer (B) divided by the potential total number of CH₂COOH groups, assuming one CH₂COOH group per NH group and two CH₂COOH groups per NH₂ group, will also be termed as “degree of substitution” in the context of the present invention.

The degree of substitution can be determined, for example, by determining the amine numbers (amine values) of polymer (B) and its respective polyamine before conversion to the CH₂COOH-substituted polymer (B), preferably according to ASTM D2074-07.

Examples of polyamines are polyvinylamine, polyalkylenepolyamine and in particular polyalkylenimines such as polypropylenimines and polyethylenimine.

Within the context of the present invention, polyalkylenepolyamines are preferably understood as meaning those polymers which comprise at least 6 nitrogen atoms and at least five C₂-C₁₀-alkylene units, preferably C₂-C₃-alkylene units, per molecule, for example pentaethylenhexamine, and in particular polyethylenimines with 6 to 30 ethylene units per molecule. Within the context of the present invention, polyalkylenepolyamines are to be understood as meaning those polymeric materials which are obtained by homo- or copolymerization of one or more cyclic imines, or by grafting a (co)polymer with at least one cyclic imine. Examples are polyvinylamines grafted with ethylenimine and polyimidoamines grafted with ethylenimine.

Preferred polmers (B) are polyalkylenimines such as polyethylenimines and polypropylenimines, polyethylenimines being preferred. Polyalkylenimines such as polyethylenimines and polypropylenimines can be linear, essentially linear or branched.

In one embodiment of the present invention, polyethylenimines are selected from highly branched polyethylenimines. Highly branched polyethylenimines are characterized by their high degree of branching (DB). The degree of branching can be determined, for example, by ¹³C-NMR spectroscopy, preferably in D₂O, and is defined as follows:

DB=D+T/D+T+L

with D (dendritic) corresponding to the fraction of tertiary amino groups, L (linear) corresponding to the fraction of secondary amino groups and T (terminal) corresponding to the fraction of primary amino groups.

Within the context of the present invention, highly branched polyethylenimines are polyethylenimines with DB in the range from 0.25 to 0.90.

In one embodiment of the present invention, polyethylenimine is selected from highly branched polyethylenimines (homopolymers) with an average molecular weight M_{w} in the range from 600 to 75 000 g/mol, preferably in the range from 800 to 25 000 g/mol.

In another embodiment of the present invention, polyethylenimines are selected from copolymers of ethylenimine, such as copolymers of ethylenimine with at least one diamine with two NH₂ groups per molecule other than ethylenimine, for example propylene imine, or with at least one compound with three NH₂ groups per molecule such as melamine.

In one embodiment of the present invention, polymer (B) is selected from branched polyethylenimines, partially or fully substituted with CH₂COOH groups, partially or fully neutralized with Na⁺.

Within the context of the present invention, polymer (B) is used in covalently modified form, and specifically such that in total up to at most 100 mol-%, preferably in total 50 to 98 mol-%, of the nitrogen atoms of the primary and secondary amino groups of the polymer (B)—percentages being based on total N atoms of the primary and secondary amino groups in polymer (B)—have been reacted with at least one carboxylic acid such as, e. g., Cl—CH₂COOH, or at least one equivalent of hydrocyanic acid (or a salt thereof) and one equivalent of formaldehyde. Within the context of the present application, said reaction (modification) can thus be, for example, an alkylation. Most preferably, up to at most 100 mol-%, preferably in total 50 to 99 mol-%, of the nitrogen atoms of the primary and secondary amino groups of the polymer (B) have been reacted with formaldehyde and hydrocyanic acid (or a salt thereof), for example by way of a Strecker synthesis. Tertiary nitrogen atoms of polyalkylenimine that may form the basis of polymer (B) are generally not bearing a CH₂COOH group.

Polymer (B) can, for example, have an average molecular weight (Mn) of at least 500 g/mol; preferably, the average molecular weight of polymer (B) is in the range from 500 to 1,000,000 g/mol, particularly preferably 800 to 50,000 g/mol, determined determination of the amine numbers (amine values), for example according to ASTM D2074-07, of the respective polyamine before alkylation and after and calculation of the respective number of CH₂COOH groups. The molecular weight refers to the respective per-sodium salt.

In aqueous solutions according to the invention, the CH₂COOH groups of polymer (B) are partially or fully neutralized with alkali metal cations. The non-neutralized groups COOH can be, for example, the free acid. It is preferred that 90 to 100 mol-% of the CH₂COOH groups of polymer (B) are in neutralized form.

It is preferred that the neutralized CH₂COOH groups of polymer (B) are neutralized with the same alkali metal as complexing agent (A).

CH₂COOH groups of polymer (B) may be neutralized, partially or fully, with any type of alkali metal cations, preferably with K⁺ and particularly preferably with Na⁺.

In one embodiment of the present invention, aqueous solutions according the invention have a pH value in the range of from 9 to 14, preferably from 9.5 to 12.

In one embodiment of the present invention, aqueous solutions according to the present invention may contain at least one inorganic base, for example potassium hydroxide or preferably sodium hydroxide. Preferred is an amount of 0.1 to 20 mol-% of inorganic base, referring to the total of COOH groups in complexing agent (A) and polymer (B).

Aqueous solutions according the invention furthermore contain water.

In one embodiment of the present invention, in aqueous solutions according to the invention, the balance of complexing agent (A) and polymer (B), and, optionally, inorganic base, is water.

In other embodiments, aqueous solutions according to the invention may contain one or more liquids or solids other than complexing agent (A) and polymer (B) and water.

In one embodiment of the present invention, aqueous solutions according to the invention further comprise

(C) in the range of from 1 to 25% by weight, preferably 3 to 15% by weight of at least one salt of at least one organic acid, hereinafter also referred to as salt (C).

In the context of the present invention, salt (C) is selected from the salts of mono- and dicarboxylic acids. Furthermore, salt (C) is different from both complexing agent (A) and polymer (B).

In a preferred embodiment of the present invention, salt (C) is selected from alkali metal salts of acetic acid, tartaric acid, lactic acid, maleic acid, fumaric acid, and malic acid.

Preferred examples of salt (C) are potassium acetate and sodium acetate, and combinations from potassium acetate and sodium acetate.

In one embodiment of the present invention, aqueous solutions according to the invention further comprise
(D) at least one polyethylene glycol with an average molecular weight Mₙ in the range of from 400 to 10,000 g/mol, hereinafter also being referred to as “polyethylene glycol (D)”, preferably 600 to 6,000 g/mol.

In one embodiment of the present invention, polyethylene glycol (D) may be capped, that is converted to a polyether, for example with one methyl group per molecule. In another embodiment, polyethylene glycol (D) bears two hydroxyl groups per molecule.

In one embodiment of the present invention, aqueous solutions according to the invention may contain in the range of from 1 to 20% by weight, preferably 5 to 15% by weight of polyethylene glycol (D).

The average molecular weight Mₙ of polyethylene glycol (D) can be determined, for example, by determining the hydroxyl number, preferably according to DIN 53240-1:2012-07.

In other embodiments of the present invention, aqueous solutions according to the invention to not contain any polyethylene glycol (D).

In one embodiment of the present invention, aqueous solutions according to the present invention do not contain any surfactant. In the context of the present invention, “do not contain any surfactant” shall mean that the total content of surfactants is below 0.1% by weight of the respective aqueous solution.

In one embodiment of the present invention, complexing agent (A) may contain minor amounts of impurities stemming from its synthesis, such as lactic acid, alanine, propionic acid or the like. “Minor amounts” in this context refer to a total of 0.1 to 1% by weight, referring to complexing agent (A).

In one embodiment of the present invention, aqueous solutions according to the invention may have a dynamic viscosity in the range of from 55 to 500 mPa·s, preferably up to 100 mPa·s, determined according to DIN 53018-1:2008-09 at 25° C.

In one embodiment of the present invention, aqueous solutions according to the invention may have a color number according to Hazen in the range of from 15 to 400, preferably to 360, determined according to DIN EN 1557:1997-03 at 25° C.

In one embodiment of the present invention, aqueous solutions according to the present invention have a total solids content in the range of from 30.01 to 65% by weight.

Aqueous solutions according to the invention exhibit extremely low a tendency of having solid precipitates of complexing agent (A) or other solids. Therefore, they can be stored and transported in pipes and/or containers without any residue, even at temperatures close to the freezing point of the respective aqueous solution according to the invention.

Another aspect of the present invention is thus the use of of aqueous solutions according to the invention for transportation in a pipe or a container. Transportation in a pipe or a container in the context of the present invention preferably does not refer to parts of the plant in which complexing agent (A) is being manufactured, nor does it refer to storage buildings that form part of the respective production plant in which complexing agent (A) has being manufactured. Containers can, for example, be selected from tanks, bottles, carts, road container, and tank wagons. Pipes can have any diameter, for example in the range of from 5 cm to 1 m, and they can be made of any material which is stable to the alkaline solution of complexing agent (A). Transportation in pipes can also include pumps that form part of the overall transportation system.

Another aspect of the present invention is a process for making aqueous solutions according to the invention, said process also being referred to as inventive process. The inventive process comprises the step of combining an aqueous solution of complexing agent (A) with polymer (B), said polymer (B) being applied as solid or in aqueous solution.

In one embodiment, said combination step may be followed by removal of excess water. Water will be removed as measure in the inventive process in particular in such embodiments when aqueous solution of complexing agent (A) has a concentration of less than 40% by weight, in particular less than 35% by weight.

In one embodiment of the present invention, the combination of aqueous solution of complexing agent (A) with polymer (B) may be performed at a temperature in the range of from 30 to 85° C., preferably 25 to 50° C. In another embodiment of the present invention, aqueous solution of complexing agent (A) can be combined with polymer (B) at ambient temperature or slightly elevated temperature, for example in the range of from 21 to 29° C.

The inventive process can be performed at any pressure, for example at a pressure in the range of from 500 mbar to 25 bar. Normal pressure is preferred.

The inventive process can be performed in any type of vessel, for example in a stirred tank reactor or in a pipe with means for dosage of polymer (B), or in a beaker, flask or bottle.

Removal of water can be achieved, for example, with the help of membranes or by evaporation. Evaporation of water can be performed by distilling off water, with or without stirring, at temperature in the range of from 20 to 65° C.

The invention is further illustrated by the following working examples.

Working Examples

Percentages refer to % by weight unless expressly noted otherwise.

The following substances were used:

Complexing agent (A.1): trisodium salt of MGDA, provided as 45% by weight aqueous solution, pH value: 13, or as powder, pH value of the respective 1% by weight aqueous solution: 13, residual moisture: 15% by weight

Polymer (B.1): polyethylenimine, N atoms alkylated with CH₂COOH groups, degree of substitution: 80.0 mol-%, COOH groups fully neutralized with NaOH, branched. Mn: 50,000 g/mol, determined by determined by determination of the amine numbers of polymer (B.1) and of its respective polyethylenimine, each determined according to ASTM D2074-07, 2007 edition, and calculation of the respective number of CH₂COOH groups. The molecular weight refers to the respective sodium salt, all COOH groups being neutralized. Polymer (B.1) was applied as 40% by weight aqueous solution.

Salt (C.1): sodium acetate, solid

I. Manufacture of aqueous solutions with high concentrations of MGDA according to the invention

I.1 Manufacture of an aqueous solution containing (A.1), (B.1) and (C.1)

A 25 ml glass bottle with plastic stopper was charged with 11.8 g of (A.1) as powder, pH value: 13, residual moisture: 15% by weight, 2 g of (C.1) and 11.2 g of demineralized water. The slurry so obtained was heated to 85° C. on a water bath until a clear solution was obtained. To said solution, 1.56 g of a 40% by weight aqueous solution of (B.1) were added under repeated shaking at 85° C. The resulting aqueous solution had a total solids content of 47.6% by weight. It was allowed to cool down to ambient temperature. Said clear solution did not show any sign of crystallization or precipitation of MGDA even after 30 days at 20° C.

I.2 Manufacture of an aqueous solution containing (A.1), (B.1) and (C.1)

A 25 ml glass bottle with plastic stopper was charged with 13.24 g of (A.1) as powder, pH value: 13, residual moisture: 15% by weight, 0.63 g of (C.1) and 11.1 g of demineralized water. The slurry so obtained was heated to 85° C. on a water bath until a clear solution was obtained. To said solution, 0.06 g of a 40% by weight aqueous solution of (B.1) were added under repeated shaking at 85° C. The resulting clear solution was allowed to cool down to ambient temperature.

Said clear solution did not show any sign of crystallization or precipitation of MGDA even after 30 days at 20° C.

I.3 Manufacture of an aqueous solution containing (A.1), (B.1) and (C.1)

A 25 ml glass bottle with plastic stopper was charged with 12.5 g of (A.1) as powder, pH value: 13, residual moisture: 15% by weight, 10.16 g of demineralized water and 2.34 g of a 40% by weight solution of (B.1). The slurry so obtained was heated to 85° C. on a water bath until a clear solution was obtained. The pH value was adjusted to 10 with glacial acetic acid. Then, the solution so obtained was allowed to cool down to ambient temperature. To 21.25 g of said solution, 3.75 g of (C.1) were added under repeated shaking at 85° C. The resulting clear solution was allowed to cool down to ambient temperature. Said clear solution did not show any sign of crystallization or precipitation of MGDA even after 30 days at 20° C.

1. An aqueous solution comprising:
a complexing agent in a range of 30% to 60% by weight, wherein the complexing agent is at least one selected from the group consisting of an alkali metal salt of methylglycine diacetic acid and an alkali metal salt of glutamic acid diacetic acid,
a polymer in a range of 700 ppm to 7% by weight, wherein the polymer is a polyamine with N atoms being partially or fully substituted with CH₂COOH groups, which are partially or fully neutralized with alkali metal cations,
wherein ppm and percentages are based on the total weight of the aqueous solution.

2. The aqueous solution according to claim 1, wherein the polyamine is at least one polymer selected from the group consisting of a polyalkylenimine and a polyvinylamine with N atoms partially or fully substituted with CH₂COOH groups, which are partially or fully neutralized with alkali metal cations.

3. The aqueous solution according to claim 1, wherein the polyamine is a polyethyleneimine with N atoms partially or fully substituted with CH₂COOH groups, which are partially or fully neutralized with Na⁺.

4. The aqueous solution according to claim 1, which has a pH value in a range of 9 to 13.

5. The aqueous solution according to claim 1, wherein a degree of substitution of the polymer is in a range of mol % to 90 mol %, based on total N atoms in the polymer.

6. The aqueous solution according to claim 1, further comprising:
a salt of an organic acid in a range of 1% to 25% by weight.

7. The aqueous solution according to claim 6, wherein the salt is at least one selected from selected from the group consisting of an alkali metal salt of acetic acid, an alkali metal salt of tartaric acid, an alkali metal salt of lactic acid, an alkali metal salt of maleic acid, an alkali metal salt of fumaric acid, and an alkali metal salt of malic acid.

8. The aqueous solution according to claim 1, further comprising:
a polyethylene glycol with an average molecular weight Mₙ in a range of 400 g/mol to 10,000 g/mol.

9. The aqueous solution according to claim 1, wherein the polymer is a branched polyethyleneimine with N atoms partially or fully substituted with CH₂COOH groups, which are partially or fully neutralized with Na⁺.

10. A process for preparing an aqueous solution according to claim 1, comprising:
combining an aqueous solution of the complexing agent with the polymer.

11. A method of transporting the aqueous solution of claim 1, comprising:
transporting the aqueous solution in a pipe or a container.
